(19) United States
(12) Patent Application Publication
(10) Pub. No.: US 2020/0311395 A1
(43) Pub. Date: Oct. 1, 2020

(54) METHOD AND APPARATUS FOR ESTIMATING AND CORRECTING HUMAN BODY POSTURE

(71) Applicant: ELECTRONICS AND TELECOMMUNICATIONS RESEARCH INSTITUTE, Daejeon (KR)

(72) Inventors: Daehwan KIM, Sejong-si (KR); Ki Tae KIM, Daejeon (KR); Yong Wan KIM, Daejeon (KR); Ki-Hong KIM, Sejong-si (KR); Ki Suk LEE, Daejeon (KR)

(73) Assignee: ELECTRONICS AND TELECOMMUNICATIONS RESEARCH INSTITUTE, Daejeon (KR)

(21) Appl. No.: 16/829,832

(22) Filed: Mar. 25, 2020

(30) Foreign Application Priority Data
Mar. 26, 2019 (KR) 10-2019-0034380

(51) Int. Cl. G06K 9/00; G06K 9/62

(52) U.S. Cl. CPC G06K 9/00342; G06K 9/00208; G06K 9/00778; G06K 9/6201

(57) ABSTRACT

A method and an apparatus for estimating and correcting a human body posture in an image are disclosed. According to the method, persons from an input image, and an individual person area corresponding to each person is obtained, human body parts constituting a person for each individual person area are detected, how much a motion of the person matches with a presented motion as a reference by comparing the human body parts with the presented motion is determined, and correction information to match with the presented motion is generated based on a result of the determining.

### CROSS-REFERENCE TO RELATED APPLICATION

This application claims priority to and the benefit of Korean Patent Application No. 10-2019-0034380 filed in the Korean Intellectual Property Office on Mar. 26, 2019, the entire contents of which are incorporated herein by reference.

### BACKGROUND OF THE INVENTION

### (a) Field of the Invention

The present invention relates to posture estimation, and more particularly, to a method and an apparatus for estimating and correcting a human body posture in an image.

### (b) Description of the Related Art

Recently, the technology of estimating and recognizing poses of the human body, that is, postures to enable intuitive interaction or training and posture correction, are widely used in various fields of application such as games, robotics, health, and the like in combination with activity recognition, posture estimation, posture recognition, computer vision, and augmented reality.

However, in order to correctly estimate the human body posture, expensive and complex equipment must be utilized in a large space. In order to solve this, recently, a technology of estimating the human body posture using a single three-dimensional (3D) video camera has been commercialized in XBOX game machines and applied to many fields. In particular, these technologies are spreading and being applied to fields such as exercise posture, health measurement, and posture correction.

However, due to the directional limitation of one camera, a part of the body still covers another part of the body, and thus there is a problem that accurate posture estimation cannot be made. Therefore, human body posture estimation methods for accurate exercise posture measurement and posture correction are needed.

Related prior art documents include a method and apparatus for real-time camera pose estimation based on image feature points described in Korean Patent Application No. 1942646.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a method and an apparatus for accurately estimating and correcting human body posture-based images captured by a single camera.

Also, the present invention has been made in an effort to provide a method and an apparatus for evaluating a human body posture that has been estimated based on images and providing correction information.

An exemplary embodiment of the present invention provides a method for estimating and correcting a human body posture in an image. The method includes: detecting, by an apparatus, persons from an input image and obtaining an individual person area corresponding to each person; detecting, by the apparatus, human body parts constituting a person for each individual person area; determining, by the apparatus, how much a motion of the person matches with presented motion as a reference by comparing the human body parts with the presented motion; and generating and providing, by the apparatus, correction information to match with presented motion based on a result of the determining.

In an implementation, the input image may be an image photographed by one imaging device.

In an implementation, the obtaining individual person area may include: detecting an area corresponding to a group of people from the input image; and obtaining an individual person area corresponding to each person by dividing and separating persons in pixels in the area corresponding to the group of people.

In an implementation, the obtaining of an individual person area corresponding to each person by dividing and separating persons in pixels in the area corresponding to the group of people may include dividing persons from the area corresponding to the group of people and separating an image area corresponding to each person in pixels by using progressive clustering and pixel-wise segmentation based on two-dimensional (2D) and three-dimensional (3D) image information to obtain the individual person area.

In an implementation, the detecting of human body parts may include: detecting human body parts for each individual person area; and combining the detected human body parts by using structural shape information of a human body to obtain posture estimation information.

In an implementation, the detecting of human body parts may further include correcting a center position of each of the combined human body parts based on an optimal center position of a joint of each human body part.

In an implementation, the correcting of a center position of the combined human body parts may include finding an optimal center position of each joint through learning according to an optimization method based on 3D image data of each part of the human body.

In an implementation, the detecting of human body parts may further include separating the human body parts whose center position is corrected, and the determining of how much a motion of the person matches with presented motion may include determining a matching degree by using the separated human body parts. In an implementation, the determining of how much a motion of the person matches with presented motion may include determining a matching degree by comparing and analyzing the human body parts with covered motion information by direction of the presented motion, wherein the covered motion information by direction of the presented motion may include information on positions and areas corresponding to human body parts covered by direction when performing the presented motion.

In an implementation, the determining of how much a motion of the person matches with presented motion may include obtaining the covered motion information by direction of the presented motion from information that is related to the presented motion and is included in a presented motion protocol, wherein the information related to the presented motion includes a distance and an angle between joints and human body parts used to perform the presented motion in each of directions.

In an implementation, the generating and providing of correction information may include: obtaining a matching degree for each human body part from the result of the determining; and generating correction information, for each human body part, including a position and an angle to match with a corresponding part of the presented motion when a matching degree of a human body part is equal to or lower than a preset value.

Another embodiment of the present invention provides an apparatus for estimating and correcting a human body posture in an image. The apparatus includes: a first interface device configured to receive an image; and a processor connected with the first interface device and configured to estimate and correct a human body posture in the image, wherein the processor is configured to: detect persons from the image and obtain an individual person area corresponding to each person; detect human body parts constituting a person for each individual person area; determine how much a motion of the person matches with a presented motion as a reference by comparing the human body parts with the presented motion; and generate and provide correction information to match with the presented motion based on a result of the determining.

In an implementation, the processor may be configured to include: a people detection unit configured to detect an area corresponding to a group of people from the input image; and a people separation unit configured to divide persons from the area corresponding to the group of people and separate an image area corresponding to each person in pixels by using progressive clustering and pixel-wise segmentation based on two-dimensional (2D) image and three-dimensional (3D) image information to obtain the individual person area.

In an implementation, the processor may be configured to include: a human body part detection unit configured to detect human body parts for each individual person area; and a human body part combination unit configured to combine the detected human body parts by using structural shape information of a human body to obtain posture estimation information.

In an implementation, the processor may be configured to include: a human body part correction unit configured to correct a center position of each of the combined human body parts based on an optimal center position of a joint of each human body part; and a human body part area separation unit configured to separate the human body parts whose center position is corrected.

In an implementation, the human body part correction unit may be configured to find an optimal center position of each joint through learning according to an optimization method based on 3D image data of each part of the human body.

In an implementation, the processor may be configured to include a motion matching unit configured to determine a matching degree by comparing and analyzing the human body parts with covered motion information by direction of the presented motion, wherein the covered motion information by direction of the presented motion may include information on positions and areas corresponding to human body parts covered by direction when performing the presented motion.

In an implementation, the processor may be configured to include: a presented motion providing unit configured to provide information that is related to the presented motion and is included in a presented motion protocol as a reference; and a motion information extraction unit configured to obtain the covered motion information by direction of the presented motion from the information related to the presented motion, wherein

the information related to the presented motion may include a distance and an angle between joints and human body parts used to perform the presented motion in each of directions.

In an implementation, the motion matching unit may be configured to determine a matching degree for each human body part by comparing and analyzing the human body parts with covered motion information by direction of the presented motion, wherein the processor may be configured to further include a motion correction unit configured to generate correction information for a human body part including a position and an angle to match with a corresponding part of the presented motion when a matching degree of the human body part is equal to or lower than a preset value.

In an implementation, the apparatus may further a second interface device connected with the processor, wherein the second interface device is configured to provide the correction information generated by the processor.

### BRIEF DESCRIPTION OF THE DRAWINGS

FIG. 1 is a diagram illustrating a structure of an apparatus for estimating and correcting a human body posture according to an exemplary embodiment of the present invention.

FIG. 2 is a diagram illustrating a structure of a presented motion providing unit of an apparatus for estimating and correcting a human body posture according to an exemplary embodiment of the present invention.

FIG. 3 is a diagram illustrating the structure of a person detection unit of the apparatus for estimating and correcting a human body posture according to an embodiment of the present invention.

FIG. 4 is a diagram illustrating the structure of a human body posture estimation unit 30 of the apparatus for estimating and correcting a human body posture according to the embodiment of the present invention.

FIG. 5 is a diagram illustrating the structure of a human body posture correction unit 40 of the apparatus for estimating and correcting a human body posture according to an embodiment of the present invention.

FIG. 6 is a diagram showing the structure of a motion information extraction unit 50 of the apparatus for estimating and correcting a human body posture according to the embodiment of the present invention.

FIG. 7 is a diagram illustrating a relationship between a motion matching unit and a motion correction unit according to an embodiment of the present invention.

FIG. 8 is a flowchart illustrating a method of estimating and correcting a human body posture according to an exemplary embodiment of the present invention.

FIG. 9 is a structural diagram of an apparatus for estimating and correcting a human body posture according to another embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising” will be understood to imply the inclusion of stated elements but not the exclusion of any other elements.

The expressions described in the singular may be interpreted as singular or plural unless an explicit expression such as “one”, “single”, and the like is used.

In addition, terms including ordinal numbers such as “first” and “second” used in embodiments of the present disclosure may be used to describe components, but the components should not be limited by the terms. The terms are only used to distinguish one component from another. For example, without departing from the scope of the present disclosure, a first component may be referred to as a second component, and similarly, the second component may be referred to as the first component.

Hereinafter, a method and an apparatus for apparatus for estimating and correcting a human body posture according to an exemplary embodiment of the present invention will be described.

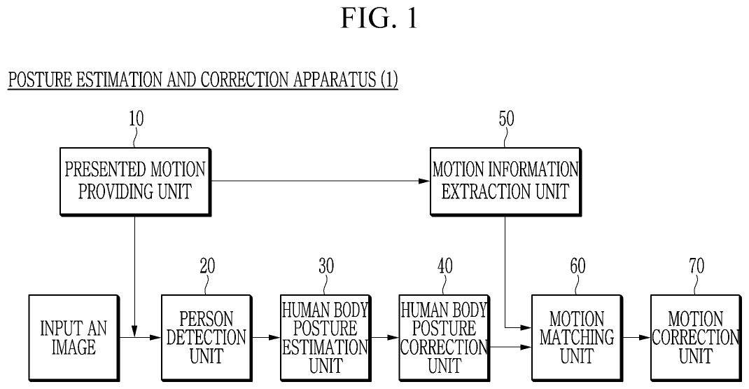

FIG. 1 is a diagram illustrating a structure of an apparatus for estimating and correcting a human body posture according to an exemplary embodiment of the present invention.

As shown in FIG. 1, the apparatus for estimating and correcting a human body posture according to an exemplary embodiment of the present invention (hereinafter, for convenience of description, referred to as a posture estimation and correction apparatus) 1 includes a presented motion providing unit 10, a person detection unit 20, a human body posture estimation unit 30, a human body posture correction unit 40, a motion information extraction unit 50, a motion matching unit 60, and a motion correction unit 70.

The presented motion providing unit 10 provides information about preset motions. For example, it provides motions according to a standardized motion protocol by an expert system. The preset motion is referred to as a “presented motion” for convenience of description.

The person detection unit 20 detects a person from an input image. Specifically, the person detection unit 20 detects a person from images photographed by one camera, and for example, detects and separates a plurality of persons from 3D images and obtains an area corresponding to a person detected in the image.

The human body posture estimation unit 30 estimates the posture of the detected person. The human body posture estimation unit 30 detects and estimates human body parts in the area corresponding to the detected person. Here, the human body parts represent parts that are separated based on joints constituting the human body. For example, the human body parts represents a part that is not physically folded in the human body, and each human body part is connected through a joint, and may include a head, a torso, a calf, a thigh, a foot, and the like.

The human body posture correction unit 40 corrects the human body parts based on the positions of the human body parts estimated by the human body posture estimation unit 30, and separates the corrected human body part into a pixel unit area.

The motion information extraction unit 50 extracts and provides covered motion information by using the presented motion provided from the presented motion providing unit 10.

The motion matching unit 60 compares and analyzes the corrected human body parts provided from the human body posture correction unit 40 with the covered motion information provided from the motion information extraction unit 50 to determine whether the motion of the human body parts matches with the presented motion.

The motion correction unit 70 provides correction information based on a matching result of the motion matching unit 60.

Next, a detailed structure and operation of each part of the posture estimation and correction apparatus 1 according to the embodiment of the present invention having such a structure will be described.

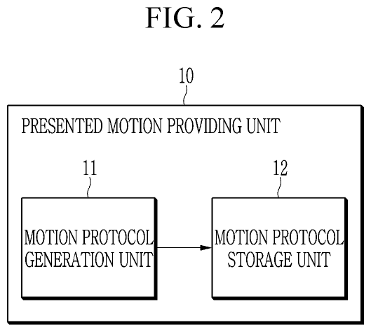

FIG. 2 is a diagram illustrating a structure of a presented motion providing unit 10 of a posture estimation and correction apparatus according to an exemplary embodiment of the present invention.

In an embodiment of the present invention, the presented motion providing unit 10 provides presented motions based on a sample protocol of motions using expert systems. Accurate posture evaluation and correction require an expert system defined by a group of experts in advance. The system can be configured differently for purposes such as exercise evaluation, posture correction, health promotion, and the like. An expert system for the purpose of evaluation or correction ensures that the absolute joint positions or angle information of the presented motions and the relative positions and angle information between the human body parts are established through size normalization regardless of body size.

Thus, as shown in FIG. 2, the presented motion providing unit 10 includes a motion protocol generation unit 11 that corresponds to such an expert system and generates a presented motion protocol, and a motion protocol storage unit 12. The presented motion protocol includes joint positions/angle information of the presented motions and the range of motion per body part available. For example, it includes information such as a distance and an angle between the joints and the human body parts used to perform a corresponding presented motion in each of a direction such as a first direction, a second direction, and the like in response to the presented motion. Thus, it can be seen which motions are made by which human body parts that move in each direction with respect to one presented motion. This information related to the presented motion is used as reference information for motion matching and correction.

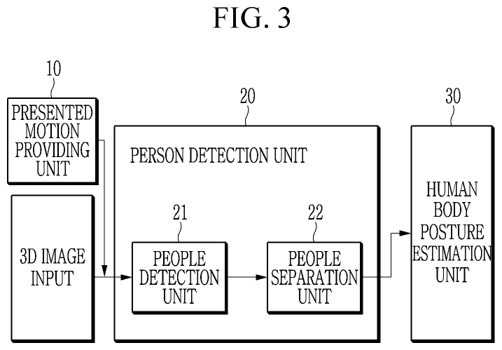

FIG. 3 is a diagram illustrating the structure of the person detection unit 20 of the posture estimation and correction apparatus according to an embodiment of the present invention.

In an embodiment of the present invention, the person detection unit 20 detects and separates a person from an image (e.g., a 3D/vision image) photographed by one imaging device.

Existing general person detection methods detect a person in an image by learning shape features of the person, or divides each object in the image into a 3D independent object unit and detects a person by determining whether the object unit is a person through volume information. These methods show good performance when people are not overlapped in the image, but when people are simultaneously detected or when people are overlapped, accurate person detection is not achieved. In addition, posture detection requires image areas in pixels for a human body, but it is difficult to obtain such image areas. Therefore, there is a need for a method of detecting multiple overlapping people and accurately detecting an area corresponding to each person in the overlapping people, rather than simply detecting a person in the image.

To this end, in the embodiment of the present invention, as shown in FIG. 3, the person detection unit 20 includes a people detection unit 21 and a people separation unit 22. The people detection unit 21 detects people from an input image (e.g., a 3D image). A large number of people can be detected in an image, which is referred to as a group of people, including the people. The people detection unit 21 includes a people group detector, and trains the people group detector by using convolutional neural network-based learning methods for 2D color images of various people groups and volume images detected by a 3D connection component method. The learned people group detector is used to detect people groups in the image. The area corresponding to the people group detected by the people detection unit 21 may be referred to as a “group area”, and the method for detecting the group area is not limited to that described above.

On the other hand, in order to accurately estimate the human body posture, it is necessary to distinguish pixels of an area corresponding to each person. The people separation unit 22 detects and separates an area corresponding to each person from the group area that is detected from the image by the people detection unit 21. Specifically, the people separation unit 22 may perform progressive clustering based on machine learning techniques and learn pixel-wise segmentation by using 2D and 3D image information in the group area detected by the people detection unit 21. This method first classifies the people at the closest distance and separates the image area corresponding to each person in pixels. Through this, people are classified and separated by pixel units of the image. For example, when some human body parts of a person located behind another person are covered or overlapped by the other person, through the people separation in pixels, it is possible to know which person the covered or overlapped human body part corresponds to.

Therefore, it is possible to know which person an arbitrary pixel corresponds to, and a pixel area separated for each person is obtained. The motion separation unit 22 detects and separates an area corresponding to each person in the group area using the method described above, but the present invention is not limited thereto.

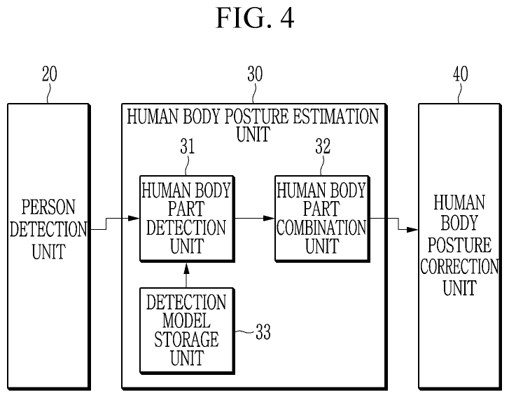

FIG. 4 is a diagram illustrating the structure of the human body posture estimation unit 30 of the posture estimation and correction apparatus according to the embodiment of the present invention.

In an embodiment of the present invention, the human body posture estimation unit 30 estimates the human body posture using an area corresponding to the person detected by the person detection unit 20, that is, an individual person area. Specifically, the human body parts of the person are detected by learning a detector for each human body part, and the like, and learning individual person areas and the detected human body parts are combined based on the structural shape information of the human body. To this end, as shown in FIG. 4, the human body posture estimation unit 30 includes a human body part detection unit 31, a human body part combination unit 32, and a detection model storage unit 33.

The human body part detection unit 31 includes a human body part detector, trains the human body part detector based on a convolutional neural network algorithm by using 2D and 3D image information, and detects each human body part in the human image by using the trained human body part detector. However, the human body part detection method of this invention is not limited to this. Through detection of a human body part, all or some of a human body part of a person may be covered and not detected, and parts that are covered are referred to as “hidden areas” for convenience of description. The hidden areas may or may not be detected.

Meanwhile, the human body part detection unit 31 uses a human body detecting model stored in the detection model storage unit 33. The human body part detection model is generated by using a number of human body part-related learning data on line or off line.

The human body part combining unit 32 combines each human body part detected by the human body part detection unit 31. The detection performance for individually detected human body parts is not very accurate because many people are entangled with each other. Therefore, in the embodiment of the present invention, the human body part combination unit 32 combines the detected human body parts by using structural shape information of the human body. In this way, the hidden areas may be deleted. In addition, the human body posture estimation is primarily performed through the combination of the human body parts. For example, posture estimation information in the form of a skeleton may be obtained.

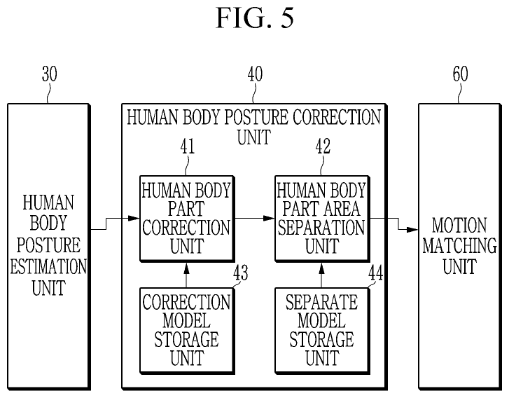

FIG. 5 is a diagram illustrating the structure of the human body posture correction unit 40 of the posture estimation and correction apparatus according to an embodiment of the present invention.

In an embodiment of the present invention, the human body posture correction unit 40 corrects the position of the human body and separates pixel areas for each body part. To this end, as shown in FIG. 5, the human body posture correction unit 40 includes a human body part correction unit 41, a human body part area separation unit 42, a correction model storage unit 43, and a separate model storage unit 44.

The human body posture estimation does not provide very precise joint position information because it is learned through a block-by-block image (e.g., the person area detected in the image). Accurate joint position information is required for the evaluation of motion or posture correction. However, since the image photographed by one photographing device provides only information of the surface corresponding to the viewing direction, it does not provide accurate joint position information. Therefore, in the embodiment of the present invention, offset-set calibration is performed on the joint position of the detected human body part based on the center of an actual 3D joint position.

The human body part correction unit 41 corrects the center position of the combined human body parts provided from the human body posture estimation unit 30. Specifically, the human body part correction unit 41 finds an optimal center position of a joint of each human body part using the human body part correcting model provided from the correction model storage unit 43, and corrects the center position of the human body part based on the found center position of the joint. For example, there may be a problem such as a position of a part of the human body part being changed (for example, the position of the arm and the position of the leg are reversed) in the information obtained by the human body posture estimation unit 30. Therefore, in the embodiment of the present invention, the optimal center positions of the joints constituting the human body part are found, and the center position of the combined human body parts are corrected based on the found optimal center positions of the joints. The optimal center position of the joint is found through learning according to optimization methods such as a Newton's method or a trust area method based on the 3D image data of each part of the human body. However, the joint center position correction method of the present invention is not limited to this.

The human body part area separation unit 42 separates the human body parts based on the positions of the joints corrected by the human body part correction unit 41. The human body part area separation unit 42 includes a human body part separator, and trains the human body part separator by using a convolutional neural network-based clustering technique based on the corrected human joint center position to separate pixel areas corresponding to human body parts. However, the human body part separation method of the present invention is not limited to this. The human body part area separation unit 42 provides information on individual human body part areas in accordance with the separation of the human body parts.

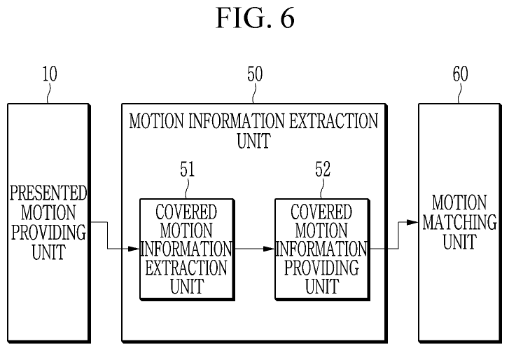

FIG. 6 is a diagram showing the structure of the motion information extraction unit 50 of the posture estimation and correction apparatus according to the embodiment of the present invention.

The motion information extraction unit 50 extracts an area in which a motion may be covered for each motion based on the presented motions, and provides covered motion information on the extracted area. When a person is photographed using one photographing device, some human body parts may be covered in a motion or posture of a human body extracted from an image photographed from one direction. In consideration with the above, the motion information extraction unit 50 includes a covered motion information extraction unit 51 and a covered motion information providing unit 52.

The covered motion information extraction unit 51 extracts covered motion information for each direction of the presented operations. To this end, two methods can be used.

Firstly, a method for scanning the real expert's motion by 360 degrees, mapping joint information to the scanned image, and then finding covered areas and positions in 360 discrete directions from the mapped image may be used. Secondly, a method for modeling a virtual human body and finding covered areas and positions by using 360-degree virtual cameras in various modeling tools may be used. However, the present invention is not limited to these methods.

As described above, the covered motion information extracted for each presented motion may be stored and managed in a lookup table, for example, the information on the positions and areas of the covered human body parts for each direction may be stored in a lookup table corresponding to the presented motion. The covered motion information providing unit 52 provides the covered motion information for each direction of the presented motion extracted by the covered motion information extraction unit 51 to the motion matching unit 60. The covered motion information providing unit 52 may store and manage a lookup table related to the covered motion as described above, and provide the corresponding information to the motion matching unit 60 as needed.

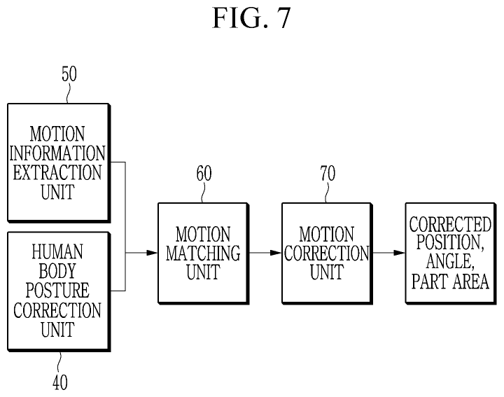

FIG. 7 is a diagram illustrating a relationship between the motion matching unit 60 and the motion correction unit 70 according to an embodiment of the present invention.

The motion matching unit 60 matches the covered motion information provided from the motion information extraction unit 50 with the information provided from the human body posture correction unit 40. The matching methods may use various machine learning and deep learning algorithms. The motion matching unit 60 matches the information on the individual human body part area provided from the human body posture correction unit 40 with the covered motion information by direction of the presented motion provided from the motion information extraction unit 50 to determine how much the posture of the person detected in the image matches the presented motion. In this case, a presented motion protocol, that is, information related to the presented motion (for example, information provided by the presented motion providing unit 10), may be additionally used. According to this matching process of the motion matching unit 60, a matching degree may be obtained for each human body part.

The motion correction unit 80 generates and provides correction information by using the matching result of the motion matching unit 70. That is, when the posture of the human body detected and estimated in the image does not match the presented motion, correction information is provided to match the presented motion. To this end, the motion correction unit 80 finds inaccurate human body parts (for example, human body parts having a matching degree equal to or lower than a preset value) based on a matching degree of each human body part, and generates correction information by comparing the found inaccurate human body parts and the information related to the presented motion (for example, the information provided by the presented motion providing unit 10). When the human body part estimated and separated from the image does not correspond to the presented motion, information such as a position, an angle, etc. for matching the human body part with the corresponding part of the presented motion are generated. The correction information for each of the human body parts may be visualized and provided. The correction information may be used for exercise evaluation, posture correction, and the like.

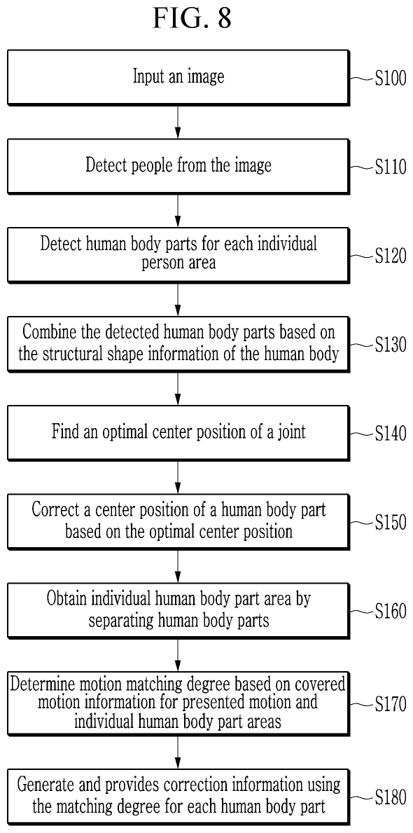

FIG. 8 is a flowchart illustrating a method of estimating and correcting a human body posture according to an exemplary embodiment of the present invention.

As shown in FIG. 8, the posture estimation and correction apparatus 1 receives an image (S100). Here, the image is an image photographed by one imaging device, but is not necessarily limited thereto.

The posture estimation and correction apparatus 1 detects people from the image (S110). A group of people including a plurality of persons is detected from the image, and an area corresponding to each person, that is, an individual person area, is obtained by dividing and separating persons in pixel units from the area corresponding to the people group.

Thereafter, the human body parts are detected for each individual person area (S120), and the detected human body parts are combined based on the structural shape information of the human body (S130). In the case of detecting the human body part for each individual person area, the hidden areas may or may not be detected. Skeleton-type posture estimation information is obtained by combining the detected human body parts.

Next, the posture estimation and correction apparatus 1 finds an optimal center position of a joint of each human body part using a human body part correction model (S140), and corrects the center position of the human body part based on the optimal center position. (S150). The human body parts are separated based on the corrected center position of the human body part to obtain individual human body part areas in pixel units (S160).

On the other hand, the posture estimation and correction apparatus 1 obtains, from the presented motion-related information provided from the presented motion providing unit 10, the information on the position and area corresponding to the human body parts that are covered when performing a presented motion for each presented motion, that is, covered motion information. By comparing and analyzing the covered motion information for each presented motion and the information on the individual human body part area obtained in step S160, it is determined how much the posture of the human body according to the parts of the human body detected in the image matches the presented motion (S170). According to the matching process, a matching degree for each human body part may be obtained.

Thereafter, the posture estimation and correction apparatus 1 generates and provides correction information using the matching result (S180). Specifically, the inaccurate human body parts are found based on the matching degree of each human body part, and the correction information to match the found inaccurate human body parts with the presented motion is generated and provided. The correction information may include a position and an angle at which the human body part is matched the corresponding part of the presented motion According to the embodiment of the present invention, the posture of the human body can be accurately estimated based on the image photographed by one camera, and the position and area of the covered human body part for each person are detected from the image to compare with the presenting motion. By performing this, it is possible to effectively perform posture evaluation or correction of the person photographed based on the image.

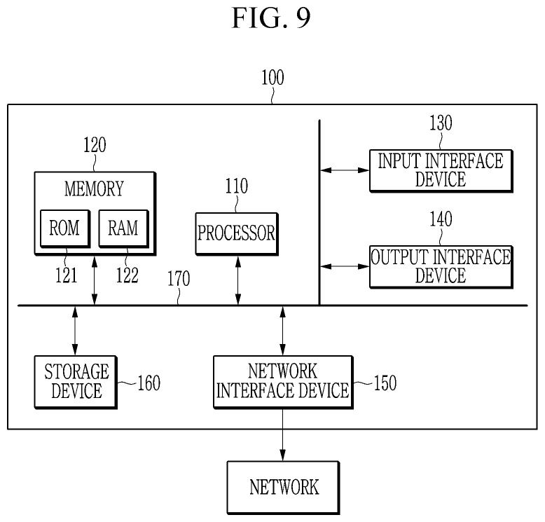

FIG. 9 is a structural diagram of a posture estimation and correction apparatus according to another embodiment of the present invention.

As shown in FIG. 9, the posture estimation and correction apparatus 100 according to another exemplary embodiment of the present invention may include includes a processor 110, a memory 120, an input interface device 130, an output interface device 140, a network interface device 150, and a storage device 160 which communicate with each other through a bus 170.

The processor 110 may be configured to embody the methods described with reference to FIGS. 1 to 8. For example, the processor 110 may be configured to perform the functions of the presented motion providing unit, the human detection unit, the human body posture estimation unit, the human body posture correction unit, the motion information extraction unit, the motion matching unit, and the motion correction unit. The processor 110 may be a central processing unit (CPU) or a semiconductor device which executes commands stored in the memory 120 or the storage device 160.

The memory 120 is connected to the processor 110 and stores various information related to an operation of the processor 110. The memory 120 may store instructions which may be executed by the processor 110 or load the instructions from the storage device 160 to temporarily store the instructions. The processor 110 may execute the instructions which are stored in the memory 120 or loaded from the memory. The memory may include a read only memory (ROM) 121 and a random access memory (RAM) 122. According to an exemplary embodiment of the present invention, the memory 120/the storage device 160 may be located inside or outside the processor 110 or may be connected to the processor 110 through various known units.

The input interface device 130 may be configured to receive image data photographed by one imaging device and provide the image data to the processor 110.

The network interface device 150 is connected to the network to be configured to transmit/receive a signal. The network interface device 150 may be configured to receive an image photographed by one imaging device via a network and provide the image to the processor 110.

The processor 110 may be configured to perform the posture estimation as the embodiment described above based on the image provided from the input interface device 130 or the network interface device 150, and generate and provide correction information according to motion matching.

The output interface device 130 may be configured to output the processing result of the processor 110, and the network interface device 150 may also be configured to transmit the processing result of the processor 110 to another device via a network. Here, the processing result may include motion matching results and/or correction information.

According to an embodiment of the present invention, it is possible to accurately human body postures based on images captured by a single camera.

In addition, the postures of the human body are estimated/corrected to evaluate or correct the movement posture of the human body, so that the information on the estimated/corrected postures is used as foundational information for interaction required for applications such as health promotion, disease prediction, posture evaluation, healthcare, home training, games, and entertainment.

Further, conventionally, only the posture of the human body is estimated from the image, but according to an embodiment of the present invention, the position and area of the covered human body part for each person are detected from the image, and the comparison and matching with the motion presented as a reference is performed, so that the evaluation or correction of postures of a person can be effectively performed based on the image,

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method for estimating and correcting a human body posture in an image, comprising:
detecting, by an apparatus, persons from an input image and obtaining an individual person area corresponding to each person;
detecting, by the apparatus, human body parts constituting a person for each individual person area
determining, by the apparatus, how much a motion of the person matches with a presented motion as a reference by comparing the human body parts with the presented motion; and
generating and providing, by the apparatus, correction information to match with the presented motion based on a result of the determining.

2. The method of claim 1, wherein
the input image is an image photographed by one imaging device.

3. The method of claim 1, wherein
the obtaining individual person area comprises:
detecting an area corresponding to a group of people from the input image; and
obtaining an individual person area corresponding to each person by dividing and separating persons in pixels in the area corresponding to the group of people.

4. The method of claim 3, wherein
the obtaining of an individual person area corresponding to each person by dividing and separating persons in pixels in the area corresponding to the group of people comprises
dividing persons from the area corresponding to the group of people and separating an image area corresponding to each person in pixels by using progressive clustering and pixel-wise segmentation based on two-dimensional (2D) and three-dimensional (3D) image information to obtain the individual person area.

5. The method of claim 1, wherein
the detecting of human body parts comprises:
detecting human body parts for each individual person area; and
combining the detected human body parts by using structural shape information of a human body to obtain posture estimation information.

6. The method of claim 5, wherein
the detecting of human body parts further comprises
correcting a center position of each of the combined human body parts based on an optimal center position of a joint of each human body part.

7. The method of claim 6, wherein
the correcting of a center position of the combined human body parts comprises
finding an optimal center position of each joint through learning according to an optimization method based on 3D image data of each part of the human body.

8. The method of claim 6, wherein
the detecting of human body parts further comprises
separating the human body parts whose center position is corrected, and
the determining of how much a motion of the person matches with presented motion comprises
determining a matching degree by using the separated human body parts.

9. The method of claim 1, wherein
the determining of how much a motion of the person matches with presented motion comprises
determining a matching degree by comparing and analyzing the human body parts with covered motion information by direction of the presented motion, wherein
the covered motion information by direction of the presented motion comprises information on positions and areas corresponding to human body parts covered by direction when performing the presented motion.

10. The method of claim 9, wherein
the determining of how much a motion of the person matches with presented motion comprises
obtaining the covered motion information by direction of the presented motion from information that is related to the presented motion and is included in a presented motion protocol, wherein the information related to the presented motion includes a distance and an angle between joints and human body parts used to perform the presented motion in each of directions.

11. The method of claim 1, wherein
the generating and providing of correction information comprises:
obtaining a matching degree for each human body part from the result of the determining; and
generating correction information for a human body part including a position and an angle to match with a corresponding part of the presented motion when a matching degree of the human body part is equal to or lower than a preset value.

12. An apparatus for estimating and correcting a human body posture in an image, comprising:
a first interface device configured to receive an image; and
a processor connected with the first interface device and configured to estimate and correct a human body posture in the image, wherein
the processor is configured to:
detect persons from the image and obtain an individual person area corresponding to each person;
detect human body parts constituting a person for each individual person area;
determine how much a motion of the person matches with a presented motion as a reference by comparing the human body parts with the presented motion; and
generate and provide correction information to match with the presented motion based on a result of the determining.

13. The apparatus of claim 12, wherein
the processor is configured to include:
a people detection unit configured to detect an area corresponding to a group of people from the input image; and
a people separation unit configured to divide persons from the area corresponding to the group of people and separate an image area corresponding to each person in pixels by using progressive clustering and pixel-wise segmentation based on two-dimensional (2D) and three-dimensional (3D) image information to obtain the individual person area.

14. The apparatus of claim 12, wherein
the processor is configured to include:
a human body part detection unit configured to detect human body parts for each individual person area; and
a human body part combination unit configured to combine the detected human body parts by using structural shape information of a human body to obtain posture estimation information.

15. The apparatus of claim 14, wherein
the processor is configured to include:
a human body part correction unit configured to correct a center position of each of the combined human body parts based on an optimal center position of a joint of each human body part; and
a human body part area separation unit configured to separate the human body parts whose center position is corrected.

16. The apparatus of claim 15, wherein
the human body part correction unit is configured to find an optimal center position of each joint through learning according to an optimization method based on 3D image data of each part of the human body.

17. The apparatus of claim 12, wherein
the processor is configured to include
a motion matching unit configured to determine a matching degree by comparing and analyzing the human body parts with covered motion information by direction of the presented motion, and
wherein the covered motion information by direction of the presented motion comprises information on positions and areas corresponding to human body parts covered by direction when performing the presented motion.

18. The apparatus of claim 17, wherein
the processor is configured to further include:
a presented motion providing unit configured to provide information that is related to the presented motion and is included in a presented motion protocol as a reference; and
a motion information extraction unit configured to obtain the covered motion information by direction of the presented motion from the information related to the presented motion, wherein
the information related to the presented motion includes a distance and an angle between joints and human body parts used to perform the presented motion in each of directions.

19. The apparatus of claim 17, wherein
the motion matching unit is configured to determine a matching degree for each human body part by comparing and analyzing the human body parts with covered motion information by direction of the presented motion, wherein
the processor is configured to further include
a motion correction unit configured to generate correction information for a human body part including a position and an angle to match with a corresponding part of the presented motion when a matching degree of the human body part is equal to or lower than a preset value.

20. The apparatus of claim 12, further comprising
a second interface device connected with the processor, wherein
the second interface device is configured to provide the correction information generated by the processor.
